(19) United States
(12) Patent Application Publication
(10) Pub. No.: US 2008/0298328 A1
(43) Pub. Date: Dec. 4, 2008

(54) TRUSTED WIRELESS COMMUNICATIONS WITH STATION-TO-STATION LINK ASSOCIATION

(76) Inventor: Suman Sharma, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/757,935

(22) Filed: Jun. 4, 2007

(51) Int. Cl. H04Q 7/24

(52) U.S. Cl. 370/338

(57) ABSTRACT

After establishing a direct station-to-station link (STSL) with a second wireless client device in a centralized network, a first wireless client device may initiate a process with the second wireless device to secure the link. Prior to securing the link, any exchange of frames that are routed through the intermediate access point (AP) may place the related security information in the payload of the frames.

### CROSS REFERENCE TO RELATED APPLICATIONS

This patent application is related to patent application Ser. No. 11/799,980, filed on May 3, 2007, and titled “Direct Station-To-Station Link Between Wireless Network Devices”, which has the same inventor and is owned by the same entity.

### BACKGROUND

When two client devices (e.g., mobile devices) in a centralized wireless network establish a direct wireless link with each other, they may need to establish encryption and/or decryption keys to provide for trusted communications over this direct link. The conventional scheme for doing this, commonly called PeerKey, requires any legacy access point (AP) in the network to be upgraded. Upgrading all access points to implement such direct links on a wide scale would be extremely expensive.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of a WLAN network with station-to-station link (STSL) capability, according to an embodiment of the invention.

FIGS. 2A and 2B show a flow diagram of a method of establishing a trusted STSL, according to an embodiment of the invention.

FIG. 3 shows a diagram of an STSL frame, according to an embodiment of the invention.

FIGS. 4A and 4B show two specific types of STSL payloads, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not. The term “mobile wireless device” is used to describe a wireless device that may be in motion while it is communicating.

Various embodiments of the invention relate to permitting two client device which are establishing a direct station-to-station link (STSL) with each other, to establish keys for trusted communications over the STSL. The exchange of information needed to establish the keys, at least that part of the exchange that is routed through an intermediate access point (AP), may be contained in the payload section of the frames communicated between the two client devices. By placing this information in the payload section of the frames rather than in the frame format, existing APs may be able to handle this data traffic without being modified to handle a new frame format.

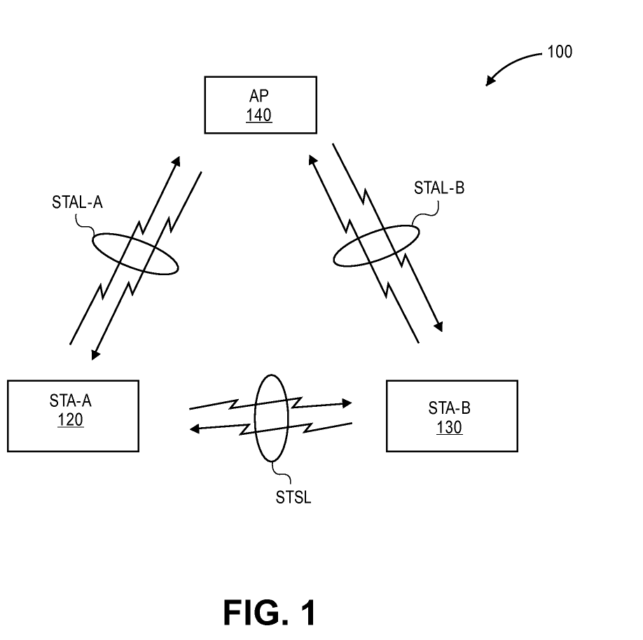

FIG. 1 shows a diagram of a WLAN network with station-to-station link (STSL) capability, according to an embodiment of the invention. Within the context of this document, the term STSL will be used to indicate a wireless communications link directly between two devices, neither of which is an access point, but both of which are communicatively associated with an access point. In some embodiments this WLAN network may comply with formats, protocols, and restrictions outlined in standard IEEE 802.11-2007, published in 2007 by the Institute of Electrical and Electronic Engineers. In the illustrated network 100, a wireless client device 120 may establish a wireless communications link with an AP 140. Another wireless client device 130 may similarly establish a wireless communications link with the same AP 140. Other wireless client devices may also be present in the network, but for simplicity of illustration they are not shown. Each wireless client device is labeled as a STA, to be consistent with industry terminology, with device 120 labeled as STA-A and device 130 labeled as STA-B. The wireless link between STA-A and the AP is labeled STAL-A and the wireless link between STA-B and the AP is labeled STAL-B. Each wireless device in FIG. 1 may contain one or more antennas to facilitate the wireless communications.

Normally, STA-A might communicate directly only with the AP, and STA-B might also communicate directly only with the AP, with any communications between STA-A and STA-B being routed through the AP, using conventional techniques. However, STA-A and STA-B may also establish a direct wireless link between themselves, with this station-to-station link labeled as STSL, so that subsequent communications between STA-A and STA-B do not have to be routed through the AP. This STSL may be established by sending the appropriate frames between STA-A and STA-B through the AP, and using the contents of the payload section of these frames to set up the STSL. By using the payload section in this manner, legacy AP's may not have to be modified to handle the STSL setup exchange. This is an advantage over using the conventional Direct Link Setup (DLS) to establish a direct link.

Once the STSL has been created between STA-A and STA-B, but before any normal data traffic is transferred over the STSL, the STSL may be secured by establishing keys for encryption, decryption, and integrity protection of that data traffic. Establishment of these keys may be accomplished by communicating frames containing the necessary information between STA-A and STA-B, using the payload section of those frames to contain the necessary information.

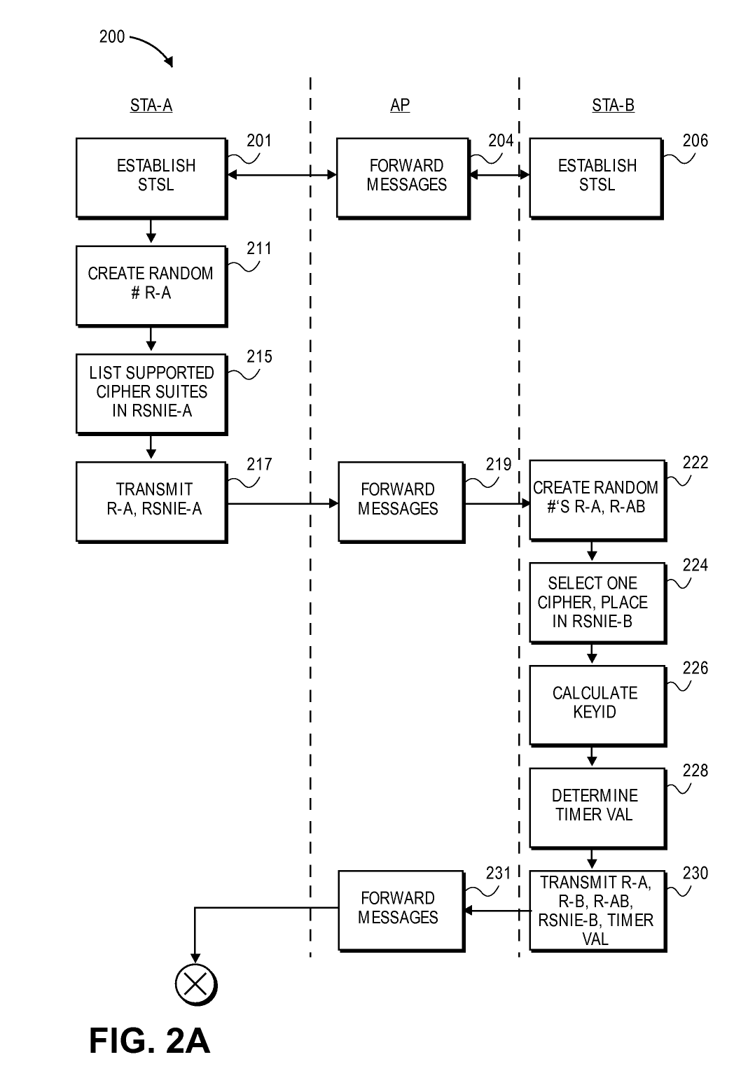

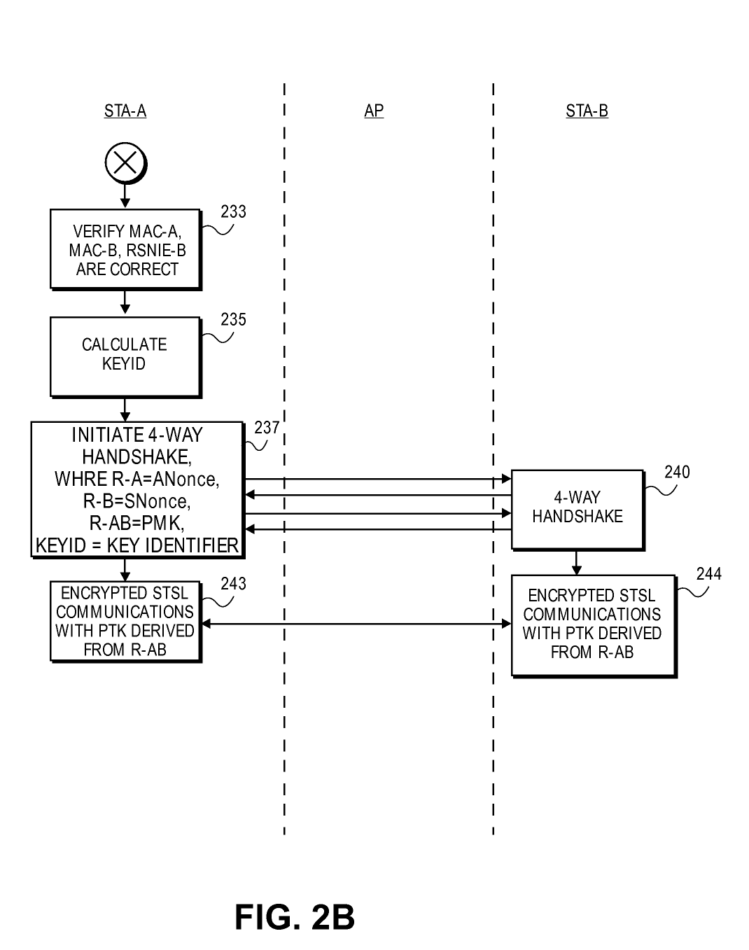

FIGS. 2A and 2B show a flow diagram of a method of establishing a trusted STSL, according to an embodiment of the invention. In the illustrated flow diagram 200, three vertical columns separated by dashed lines indicate the operations performed by devices designated STA-A, STA-B, and the associated AP, respectively (see FIG. 1). The process may begin at the top of FIG. 2A when STA-A and STA-B establish an STSL by communicating through the AP (which forwards frames between STA-A and STA-B), as shown at 201, 204, and 206. Once the STSL direct link is set up, STA-A and STA-B may establish keys for communicating trusted data with each other over the STSL. The remainder of FIGS. 2A and 2B are devoted to a process for establishing these keys. This particular example assumes that STA-A initiates the process, but STA-B could just as easily initiate it.

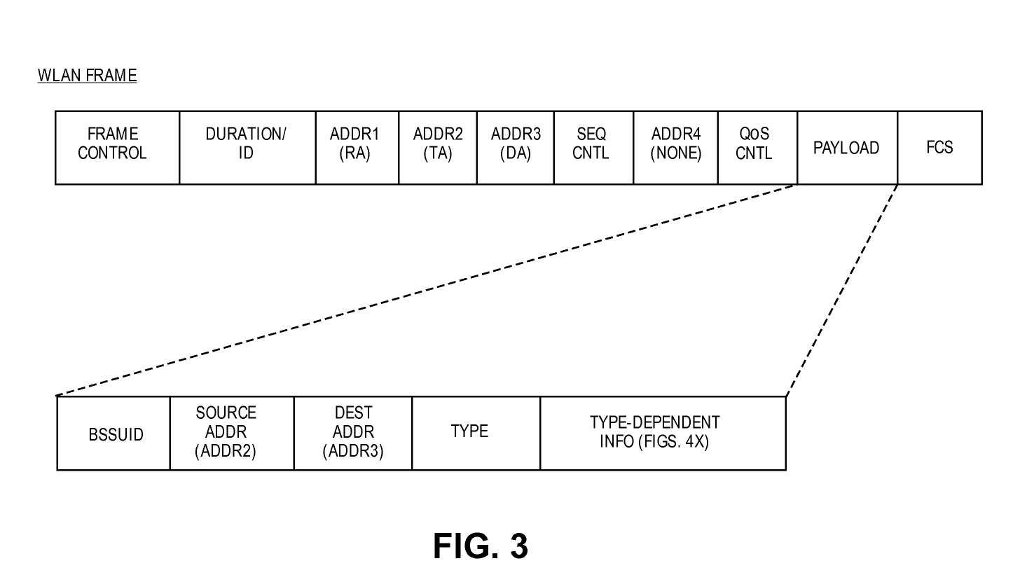

At 211, STA-A may create a random number, labeled R-A, to be used later. (Note: in this document, the term ‘random number’ may include any number that is generated in either a truly random or a pseudo-random manner. The degree of ‘randomness’ in the number may effect the level of security achieved, but does not affect the basic process described herein.) At 215, STA-A may also create a list of the cipher suites that it supports, and put this list into an information element labeled RSNIE-A. At 217, STA-A may transmit a frame to STA-B containing the random number R-A and the information element RSNIE-A, as well as any other needed information to initiate the process. This frame may routed to STA-B through the intermediate AP, which forwards the information to STA-B at 219, using the format shown in FIG. 3. This frame may be a data frame, and confidentiality and authenticity of the frame may be maintained using methods established earlier between STA-A and the AP, and between STA-B and the AP.

After receiving this frame, at 222 STA-B may create it's own random number R-B, as well as another random number R-AB to be later used as a master key. At 224, STA-B may select a particular cipher from the cipher suite list provided by STA-A, and place that selected cipher into its own information element RSNIE-B. At 226, STA-B may also calculate a KeyID. In one embodiment, this KeyID may be calculated as

KeyID=Truncate-128(hash(R-B, ADDR-B, R-A, ADDR-A))

where ADDR-A is the address of STA-A and ADDR-B is the address of STA-B. However, other embodiments may calculate the KeyID in other ways. Finally, at 228 STA-B may determine a timer value TimerVal, to be used as an expiry timer value for Master Key R-AB. At 230, STA-B may transmit a frame to STA-A containing R-A, R-B, R-AB, RSNIE-B, and TimerVal. This frame may be routed to STA-A through the AP at 231.

The flow diagram of FIG. 2A is continued in FIG. 2B at point “X”. When STA-A receives the frame from STA-B, at 233 it may verify that addresses ADDR-A and ADDR-B represent the correct addresses for STA-A and STA-B, respectively, to make sure this frame is the correct frame for this process. STA-A may also verify that the cipher specified in RSNIE-B is one of the ciphers it previously listed in RSNIE-A. At 235, STA-A may calculate the value of KeyID, using the same algorithm that was used by STA-B. By independently calculating the value of KeyID in each STA, there is no need to send that value over the as-yet-unsecured channel.

At 237, STA-A may initiate a handshake exchange with STA-B, which continues the exchange at 240. For this handshake exchange, STA-A and STA-B may communicate directly with each other using the STSL, rather than routing their communications through the AP. In this particular example, the handshake exchange may conform to the protocols of the 4-way handshake defined in section 8.5.3 of IEEE 802.11-2007, but other embodiments may use a different handshake exchange. In this particular 4-way handshake example, using the terminology of IEEE 802. 11-2007, R-A may correspond to the ANonce, R-B may correspond to the SNonce, R-AB may correspond to the pairwise master key (PMK), and KeyID may correspond with the Key Identifier.

At 243 and 244, STA-A and STA-B may communicate encrypted data frames with each other, using a pairwise transient key (PTK) derived from the PMK (R-AB) as an encryption key. New PTK's may be derived from PMK from time to time during the period that this particular STSL is in effect.

FIG. 3 shows a diagram of an STSL frame, according to an embodiment of the invention. This format may be used when STA-A and STA-B are communicating key exchange information with each other through the AP (see 219 and 231 of FIG. 2A). In the example of FIG. 3, the basic format of a WLAN frame is used. In some embodiments, the specific WLAN format shown may be used, but other embodiments may differ. In this format, the frame begins with a Frame Control section, which specifies various parameters of the frame, followed by a Duration/ID section, which among other things indicates the length of the frame.

This is shown followed by three addresses. ADDR1 may represent the receiving address RA of the device that is to directly receive this frame, which would be the AP when the source STA initiates the frame, but would be the destination STA when the AP forwards that frame. ADDR2 may represent the transmitting address TA, which would be the source STA when the frame is sent to the AP, but would be the AP when that frame is forwarded to the destination STA. ADDR3 may represent the destination STA. In the case of STA-A sending a frame to STA-B through the AP, the Source STA would be STA-A and the Destination STA would be STA-B.

These addresses may be followed by a Sequence Control section, to help in reconstructing a string of multiple frames that might be received out of order if some of them have to be re-transmitted due to errors in the received signal. A fourth address may optionally follow, but may be unused in this particular implementation. QoS CNTL may be used to indicate that the protocols for Quality of Service communications are being used. This is then followed by the payload section, and then a Frame Checksum section FCS which may be used to detect errors in the received frame (which could result in the aforementioned retransmissions).

An expanded view of the payload section is shown in the bottom part of FIG. 3. The format of this payload section may be used to indicate this is a frame that pertains to an STSL connection between two client devices in the network. Although various fields within the payload are shown arranged in a particular order, other embodiments may use a different arrangement and/or somewhat different fields than those shown. In the illustrated embodiment, a basic service set unique identifier (BSSUID) contains the set of parameters necessary to identify the BSS uniquely. In some embodiments the BSSUID field will contain the BSS ID, the applicable regulatory class, and the channel number. A source address, labeled SOURCE ADDR, indicates the STA that created this payload and/or is initiating this frame. A destination address, labeled DEST ADDR, indicates the device that is the ultimate recipient of the information in the payload. These are the two devices that are involved in the STSL connection.

These addresses may then be followed by the TYPE field, to indicate which of several types of STSL communication is represented in this payload. For example, TYPE may indicate things such as, but not limited to: 1) a request to establish an STSL between two client devices, 2) a response to that request to establish an STSL, either accepting or rejecting the request, 3) a request to establish a trusted link by creating and exchanging keys, 4) a response to the request to establish the trusted link. One or more fields, collectively labeled TYPE-DEPENDENT INFO, may follow the TYPE field. The nature and format of these fields may be dependent on what was specified in the TYPE field.

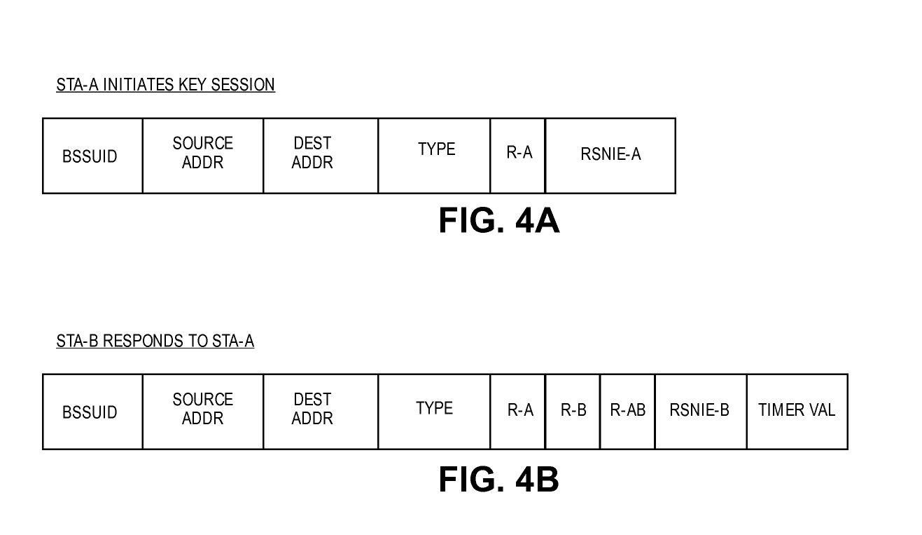

FIGS. 4A and 4B show two specific types of STSL payloads, according to an embodiment of the invention. The first four fields (BSSUID, SOURCE ADDR, DEST ADDR, and TYPE) of each of these are as previously described in FIG. 3, while the remaining sub-fields expand on the TYPE-DEPENDENT INFO of FIG. 3.

FIG. 4A shows the format of the payload of a request to establish a trusted link (for example, the frame forwarded by the AP at 219 of FIG. 2A). For this example, assume that STA-A wishes to establish the trusted link. R-A may be the random number generated by STA-A, as described earlier for FIG. 2A. RSNIE-A may contain the list of cipher suites supported by STA-A, also as described earlier for FIG. 2A.

FIG. 4B shows the format of the payload of a response to the frame of FIG. 4A (for example, the frame forwarded by the AP at 231 in FIG. 2A). For this example, STA-B would be the device originating the response frame. R-A, R-B, and R-AB may represent the random numbers previous described for FIG. 2A. RSNIE-B and Timer Val may also represent the values described earlier for FIG. 2A. Because the information needed to establish the requisite keys is contained in the payload section of the WLAN frame, older APs with lesser capabilities may be able to function in these exchanges without having to be upgraded.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. A method, comprising:
establishing a direct station-to-station communications link (STSL) with another client device in a centralized wireless network, in which the STSL is established using contents of payloads of one or more frames routed through an access point;
initiating a process with the other client device to establish keys to be used in trusted communications with the other client device over the STSL, said initiating to include using payloads of additional frames to the other client device routed through the access point.

2. The method of claim 1, further comprising using a 4-way handshake communications exchange, the exchange routed directly through the STSL.

3. The method of claim 1, wherein said initiating comprises transmitting a list of ciphers usable by the initiating client device.

4. The method of claim 3, wherein said initiating further comprises receiving from the other client device one of the ciphers selected by the other client device from the list of ciphers.

5. The method of claim 1, further comprising determining at least one random number in the initiating client device and receiving at least a second random number from the other client device.

6. An apparatus, comprising a wireless communications client device to:
establish a direct station-to-station communications link (STSL) with another client device in a centralized wireless network, in which the STSL is established using contents of payloads of one or more frames routed through an access point;
initiate a process with the other client device to establish keys to be used in trusted communications with the other client device over the STSL, the process to include using payloads of additional frames to the other client device routed through the access point.

7. The apparatus of claim 8, wherein the wireless communications device is further to use a 4-way handshake communications exchange, the exchange to be routed directly through the STSL.

8. The apparatus of claim 6, wherein the process is to comprise transmitting a list of ciphers usable by the initiating client device.

9. The apparatus of claim 8, wherein the process is further to comprise receiving from the other client device one of the ciphers selected by the other client device from the list of ciphers.

10. The apparatus of claim 6, wherein the process is to further comprise determining at least one random number in the initiating client device and receiving at least a second random number from the other client device.

11. An article comprising
a tangible machine-readable medium that contains instructions, which when executed by one or more processors result in performing operations comprising:
establishing a direct station-to-station communications link (STSL) with another client device in a centralized wireless network, in which the STSL is established using contents of payloads of one or more frames routed through an access point;
initiating a process with the other client device to establish keys to be used in trusted communications with the other client device over the STSL, said initiating to include using payloads of additional frames to the other client device routed through the access point.

12. The article of claim 11, wherein the operations further comprise using a 4-way handshake communications exchange, the exchange routed directly through the STSL.

13. The article of claim 11, wherein the operation of initiating comprises transmitting a list of ciphers usable by the initiating client device.

14. The article of claim 13, wherein the operation of initiating further comprises receiving from the other client device one of the ciphers selected by the other client device from the list of ciphers.

15. The article of claim 11, wherein the operations further comprise determining at least one random number in the initiating client device and receiving at least a second random number from the other client device.
